(19) United States
(12) Patent Application Publication
(10) Pub. No.: US 2025/0093252 A1
(43) Pub. Date: Mar. 20, 2025

(54) STRETCHABLE COUPLING TUBE

(71) Applicant: Standard BioTools Canada Inc., Markham (CA)

(72) Inventors: Alexander Loboda, Markham (CA); Adam Carew, Markham (CA)

(73) Assignee: Standard BioTools Canada Inc., Markham, ON (CA)

(21) Appl. No.: 18/726,639

(22) PCT Filed: Jan. 9, 2023
(86) PCT No.: PCT/US2023/010394

§ 371 Date: Jul. 3, 2024

Related U.S. Application Data
(60) Provisional application No. 63/266,550, filed on Jan. 7, 2022.
(60) Provisional application No. 63/437,430, filed on Jan. 6, 2023.

(51) Int. Cl. G01N 15/1404; G01N 15/10; H01J 49/00; H01J 49/04; H01J 49/10

(52) U.S. Cl. CPC G01N 15/1404; H01J 49/0031; H01J 49/0463; H01J 49/105; G01N 2015/1006

(57) ABSTRACT

A coupling tube made of a stretchable elastomeric material. The “stretchy” coupling tubing allows for improved reliability/repeatability of coupling performance. For example, the stretch provided can take up tolerances between positions of imager and reader instruments. In one example, the stretch can take up tolerances between positions of the junction between the rigid portion of tubing inside the IMC unit and the injector to an ionization source. The coupling tube may also be provided with a reduced inner diameter (ID) as compared to standard coupling components. A taper in the inner diameter (ID) can occur before the flow enters the stretchable coupling tube. Barbed ends may also be provided for securing the coupling tube into place.

### CROSS REFERENCE

This application claims priority to and the benefit of U.S. Provisional Patent Application No. 63/266,550, filed Jan. 7, 2022, and U.S. Provisional Patent Application No. 63/437,430, filed Jan. 6, 2023, the entire contents of both of which are hereby incorporated by reference in their entirety for all purposes.

### FIELD OF THE DISCLOSURE

This disclosure relates to a coupling tube that is used in connection with mass cytometry equipment. The coupling tube is designed to secure instruments to one another while maintaining laminar flow, lowering potential of turbulence, and providing optimal results. In a specific example, the disclosed improved coupling tube transfers ablated plumes between a laser ablation source and a mass cytometer, such as coupling between an Imaging Mass Cytometry™ unit (IMC™) unit and a CyTOF® unit, including CyTOF XT™.

### BACKGROUND

Laser ablation combined with inductively coupled plasma mass spectrometry (ICP-MS) or other ionization sources can be used for imaging of biological samples (cells, tissues, etc.) labeled with elemental tags. Each laser pulse generates a plume of ablated material from the sample which can be transferred to be ionized for further analysis by a mass analyzer. The information acquired from the laser pulses at each location on the sample can then be used for imaging the sample based on its analyzed content.

The system may include a laser ablation mass cytometer that has (i) a laser ablation source, (ii) an injector adapted to couple the laser ablation source with an ICP (inductively coupled plasma) source or other ionization source and (iii) a mass analyzer. As shown in FIGS. 1A and 1B, in one example, a pulse of a laser beam is directed to a sample for generating an ablated plume of the sample. The plume of sample is then transferred from an ablation zone to an injector that couples the laser ablation source with an ICP (inductively coupled plasma) of a mass cytometer or other ionization source. The transfer may take place through a “conduit,” which generally includes rigid tubing, a “coupling tube” for continued transfer of the plume through to the injector and then to other equipment, along with the injector (all of which may be collectively referred to as a “conduit” or “flow path” herein).

Referring now specifically to FIG. 1C, the pixel/sample material starts by laser ablation and is then moved into a conduit, the first part of which is a rigid tubing. The term “rigid tubing” is used herein to refer to a portion of the transfer conduit between laser ablation and the injector inlet. The tubing is generally rigid, in that it does not substantially flex or stretch. The rigid tubing has an inlet positioned within the laser ablation source, and the inlet captures each distinct ablated plume as it is generated. This rigid tubing may be a rigid portion of the conduit located within an IMC (Imaging Mass Cytometry) unit or other ionization source.

A coupling tube may be used to secure the rigid tubing to the injector. The coupling tube serves to connect the “imager” instrument and the “reader” instrument. The injector injects the particles of the plume dispersed in the gas flow into the ionization source torch. The ionization source ionizes each of the distinctively captured and transferred ablated plumes to generate ions for mass cytometry analysis. One example of such a system is shown and described by co-pending U.S. Application Publication No. 2019/0271630, now U.S. Pat. No. 10,705,006, the entire contents of which are incorporated herein by reference. The present disclosure provides an improved coupling tube as part of the transfer channel which transfers the ablated plumes between the laser ablation source and the mass cytometer.

### SUMMARY

The present disclosure relates to a coupling tube made of a stretchable elastomeric material. The “stretchy” coupling tubing allows for improved reliability/repeatability of coupling performance. For example, the stretch provided can take up tolerances between positions of imager and reader instruments. In one example, the stretch can take up tolerances between positions of the junction between the rigid portion of tubing inside the IMC unit and the injector to an ionization source. In another example, improved laminar flow, lowering potential of turbulence, and/or optimal results can be obtained. The coupling tube may also be provided with a reduced inner diameter (ID) as compared to standard coupling components in mass spectrometry and related fields. A taper in the inner diameter (ID) can occur before the flow enters the stretchable coupling tube and a taper can also occur after the stretchable coupling tube. Barbed ends may also be provided for securing the coupling tube into place.

### BRIEF DESCRIPTION OF THE DRAWINGS

FIG. 1A shows a prior art schematic of an ablation sampling system.

FIG. 1B shows a prior art schematic direct injector inlet without the sampling cone of FIG. 1A.

FIG. 1C shows a schematic of flow through the system of FIG. 1A.

FIG. 2 shows an example of tagged plumes and the potential for cross talk.

FIG. 3A shows a schematic of ablation sampling with a taper in the sampling cone according to embodiments of the present invention.

FIG. 3B shows a schematic of ablation sampling with a taper in the rigid tubing according to embodiments of the present invention.

FIG. 3C shows a schematic of ablation sampling with a taper in the junction between rigid tubing and a stretchable coupling tube according to embodiments of the present invention.

FIG. 3D shows a schematic of ablation sampling with a taper in the junction between a stretchable coupling tube and an injector according to embodiments of the present invention.

FIG. 4 shows a side cross-sectional view of a rigid tubing of an ablation chamber injector connecting to a stretchable coupling tube according to embodiments of the present invention.

FIG. 5 shows the injector side of the ablation plume transfer channel/conduit according to embodiments of the present invention.

FIG. 6 shows a connection end junction according to embodiments of the present invention.

FIG. 7 shows two junctions that function to connect various tubing portions together according to embodiments of the present invention.

FIG. 8 illustrates an exemplary test setup using an optical post on a linear stage, driven downwards into a fixed coupling tube according to embodiments of the present invention.

FIG. 9 illustrates a schematic of a test setup to test sag of a coupling tube according to embodiments of the present invention.

FIG. 10 shows a graph plotting 800 Hz plume crosstalk against applied sag that was added to the coupling tube according to embodiments of the present invention.

FIG. 11 illustrates a flowchart of an example of a process for using a coupling tube for ablation sampling according to embodiments of the present invention.

FIG. 12 illustrates a schematic of an example of a system for using a coupling tube for ablation sampling according to embodiments of the present invention.

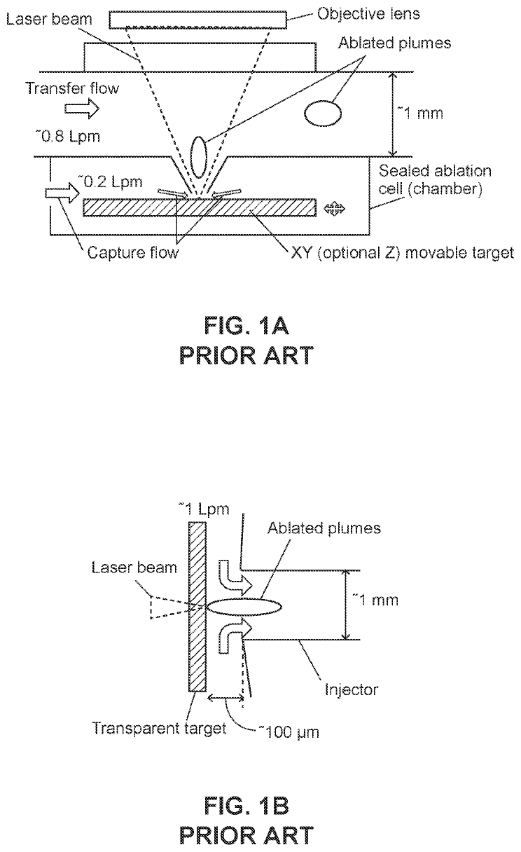

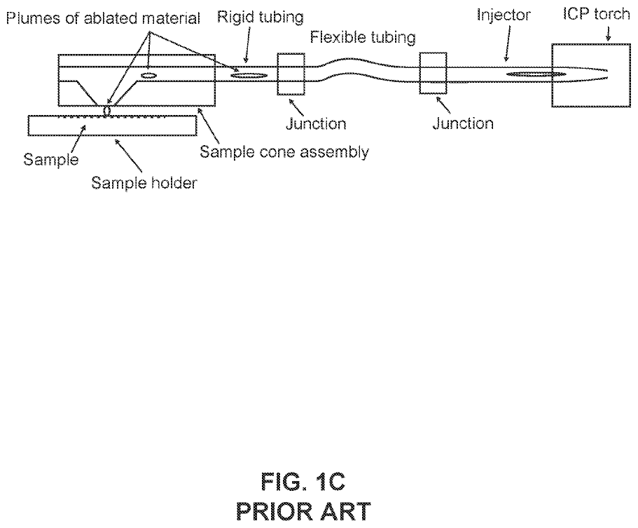

### DETAILED DESCRIPTION

As additional background for understanding of this disclosure, Imaging Mass Cytometry™ (IMC™) requires good time fidelity of the arrival of the ablation plumes in the plasma in order to construct the ion image from the detected plume sequence. In this context, “time fidelity” refers to how well correlated the arrival time of the plume to the plasma is to the time of the corresponding laser shot, as well as how narrowly-distributed the arrival times of the individual particles that make up the plume are. These two effects may also be described as “arrival time jitter” between individual plumes and as “time broadening” of individual plumes during transit. Without sufficient timing fidelity, plumes from sequential laser ablation events can blur together, resulting in a “smearing” of the final tissue image (reconstructed from ion signals) or other serious imaging artifacts, which is undesirable.

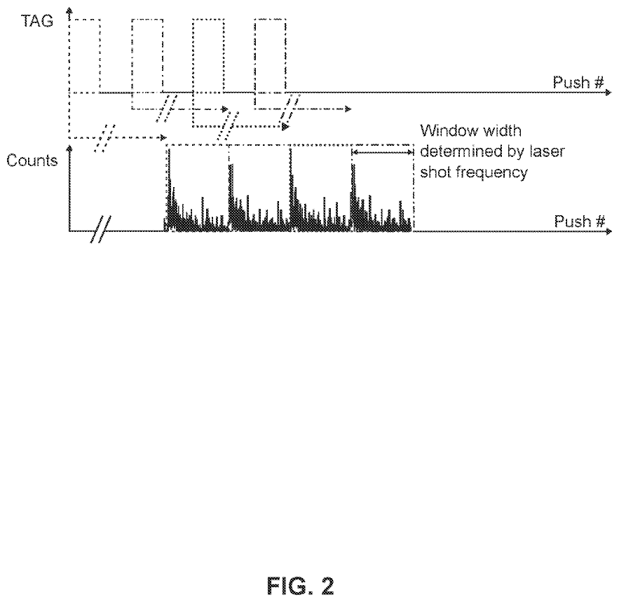

As shown in FIG. 2, each plume is associated with a “tag” input. This is a channel in the acquisition system that identifies the arrival of the laser pulse and allows the system to identify the range of the TOF (time-of-flight) pushes that correspond to that shot. For example, the portion of the signal from one shot which lies inside other windows is the “cross talk” (CT) for that plume. Usually, several plumes are summed together to generate a cleaner, more representative “accumulated” transient, which is used to perform cross talk measurement.

To ensure low cross talk, the plumes must be transferred from the site of ablation to the plasma by a laminar flow of gas. A laminar flow ensures predictable and consistent transport of material. Turbulence in the flow may result in broadening of the plumes and loss of temporal coherence. Turbulence may also result in aerosol particles in the plume contacting the walls of the conduit and sticking there. This results in sensitivity loss and contamination of the conduit. Thus, a turbulent flow regime is to be avoided.

The requirement of ensuring low cross talk and a laminar flow regime can also become difficult to satisfy as pixel acquisition rate increases because there will be a non-zero width of the plume (transient width). However, pixel acquisition rate is currently one of the primary limiting parameters that determine the total throughput of an IMC instrument, so it is critical to ensure that the pixel rate is as high as possible.

One way to limit the broadening of the transients in the conduit is to decrease the time that the plume resides in the gas flow. This reduces the time available for the plume aerosol to diffuse away from the fastest streamlines (on the centerline of the flow), which is one of the phenomena that can result in broadening. Another benefit of decreasing the overall transport time is that arrivals of two particles located in streamlines of different velocities (e.g. 100% of top velocity and 90% of top velocity) will become closer to each other proportionally to the overall transport time. However, to decrease the transit time, it is not possible to simply increase the flow, because the chamber gas flow is determined by the geometry of the ablation sampling cone, and the overall gas flow through the transfer channel/conduit is determined by the properties of the plasma in the ionization torch.

Beyond ensuring that laminar flow is maintained, it is also desirable to avoid any sharp discontinuities in the inner surface of the flow channel walls, such as those caused by decentration at a tubing junction. Any such defect in the inner surface of the channel can result in local turbulence forming in an otherwise laminar system, which could cause disruption to the flow and disturb the plumes as they pass. It has been found that any changes to the inner diameter of the conduit should be done carefully, as some geometries are more likely to generate turbulence than others. In particular, it can be easier to maintain laminar flow when decreasing a conduit ID than while increasing it. As such, another attempt to improve the timing of the plume transport has been to decrease the inner diameter (ID) of the length of the coupling tube. However, as the inner diameter was decreased, other problems were experienced, such as the Dean vortex effect and the effect of some mechanical tolerances being mismatched.

Finally, it is desirable for the flow channel between instruments to be maintained as straight as possible for best performance, as any curvature of the flow channel can result in the generation of Dean vortexes, which cause radial vorticity in curved tubes above certain critical flow values. Thus, even for perfect laminar flow, if the potentially flexible (non-stretchable) portion of the flow channel (the coupling tube) is significantly curved, the transient performance can be adversely affected. However, the use of rigid, straight tubes can create problems with alignment tolerances. One example of use of straight, small ID, rigid tubes to carry time-resolved ablation plumes from an ablation chamber into a ICP mass analyzer is described by U.S. Pat. No. 10,285,255. Such a straight rigid tube requires strict alignment tolerancing between the ablation unit and the ICP-MS (or other ionization source). Use of a perfectly-straight coupling tube is difficult to achieve using simple alignment tools, and it puts the tubing assembly at risk for damage, because any motion of the ablation chamber (which is free to move on its spring suspension) with respect to the fixed CyTOF XT could break the glued joints on the ends of the assembly. The straight tubing becomes a conduit for vibrations from the CyTOF. Such vibrations affect the ability of IMC optics to place ablation shots at equal distances which in turn result in image artifacts.

Other analytical techniques make use of “flexible” and elastic transfer tubes, but these operate in substantially different flow regimes. One example is used to transport ionized samples to a mass analyzer unit, described by U.S. Publication No. 2020/0121229. In this publication, the gas sample is partially ionized inside the tube. The objective of the 2020/0121229 “flexible” and elastic tube is not to suppress the broadening of the ablation plume, but as a way to connect a sampling region located a long distance away from a mass spectrometer inlet. Also, liquid transfer through use of flexible/stretchable tubes (e.g., via peristaltic pumps), differs from the present disclosure in that properties that need to be addressed with respect to liquid flow are substantially different from properties that need to be addressed with respect to gas flow.

It is thus desirable to design a coupling tube that would be robust enough to tolerate a range of movement of the IMC unit, not transfer vibration energy from CYTOF to the IMC optics in a significant way, as well as provide improved performance to give better margin on the cross-talk spectrum. It was also desirable to provide a coupling tube that would allow for proper alignment using a simple alignment tool. It was also desirable to provide a coupling tube that allows a strong connection at its ends, rather than involving gluing of a semi-flexible plastic tube into a machined hard plastic end piece. A glued joint could slide off the injector, or the injector could be pulled out of the injector holder. It was further desirable to ensure that the ID was matched across the junction as close as possible in order to prevent turbulence.

Accordingly, the present disclosure relates to a coupling tube that addresses many of these problems. The new coupling tube comprises a length of stretchable elastomeric tubing, terminated at each end with a machined barbed fitting. The inner diameter (ID) of the coupling tube is reduced compared to the ID of the tubing currently used in the vicinity of the ablation sampling cone. In some embodiments it is possible to consistently acquire data faster, for example in the range of 400-1000 pixels or more per second. It is possible to provide a tapered section inserted between the end of the rigid tubing and the coupling tube to maintain ID continuity. The disclosed features and the tapering section can help avoid altering the ablation sampling geometry during transfer of the plume.

### Stretchable Material

In a first aspect, the disclosed coupling tube is made of a stretchable elastomeric material. The stretchable material of the coupling tube allows for improved reliability/repeatability of coupling performance. The stretch takes up/absorbs tolerances in positions between instruments. As used herein, the term “stretchable” is used to mean a material that can be stretched a few millimeters or more, and once released, returns to its original length, having at least some type of elastic rebound. In one example, stretchable means a material that can be stretched about 0.5 mm to about 10 mm. In one example, stretchable tubing experiences only elastic deformation for elongation factors of up to 20% and applied force of up to around 20 N. (By contrast, the prior-art semi-flexible tubing would experience significant plastic deformation at this elongation, requiring substantially higher force.) By replacing the currently-used semi-flexible FEP (fluorinated ethylene propylene) tubing used in HTI couplings with a stretchable elastic tubing material, the tubing can remain taut without posing danger to coupling assembly integrity. This can also accommodate the variation in distance between instruments so that the coupling maintains minimal stretch at a minimum distance. The coupling tube can be made just slightly shorter than the distance between machines so that it stretches the distance, but remains relatively taut. It is also possible to select a tubing material and attachment technique that ensures that the coupling tube can withstand stretching to accommodate a maximum distance. Providing a stretchable tube allows a generally straight connection.

An additional benefit of the disclosed stretchable tubing is that it simplifies the design of an alignment jig to place the Deuterium unit in the correct position relative to the CyTOF XT unit. An alignment jig may be used to establish a minimum distance between the two instruments. It is then sufficient to ensure that the length of the tubing is less than the minimum distance between the two machines, such that at minimum gap, the coupling tube is still under nominal tension. By keeping the tubing under tension, the tube remains essentially straight between the two connection points. (Although gravity can make the coupling tube sag a bit, its effect is negligible for this application.) Additionally, imperfect positioning in vertical or horizontal dimensions could also lead to a “non-straight” tubing, but studies have shown that this is tolerable to a degree. The coupling alignment jig can also serve to align the two machines side-to-side, which can further minimize any bends in the coupling tube.

In one specific example, the coupling tube may be made of a fluoropolymer elastomer. One specific exemplary fluoroelastomer that may be used is Viton™. Products made with Viton™ fluoroelastomers generally retain their flexibility, shape, and seal when exposed to chemicals and high temperatures. Other materials that may be used include but are not limited to latex, silicone, flexible and stretchable PVC tubing (e.g., Tygon), EPDM, AFLAS, Nitrile, Neoprene, Fluorosilicone, Chemraz (FFKM), or any combination thereof of any of the possible materials listed.

### Inner Diameter

In another aspect, the inner diameter (ID) of the coupling tube is reduced as compared to traditional or standard coupling tubes used for this purpose. This reduced ID is expected to have a positive impact on transient quality (until the diameter reaches such a small range that the flow crosses into a turbulent transition, as outlined below). An inner diameter of the coupling tube may be in a range from 0.1 mm to 10.0 mm. An exemplary inner diameter may be in a range from 0.3 mm to 6.0 mm. The inner diameter for flow may be around 0.5 mm to about 1.0 mm ID. In a specific example, the ID of the coupling tube may be about 0.8 mm. The ID range refers to coupling tube ID that may or may not be stretched. That is, the ID may be 0.3 mm to 6.0 mm in a stretched or an unstretched state. The reduced ID of the coupling tube provides reduction of minimum CT (cross-talk) over a standard coupling ID, which is typically about 1.5 to about 2.0 mm. Reducing the coupling tube ID has been found to reduce transit time. In turn, this reduced transit time can reduce transient broadening effects, which are exaggerated by long travel distances as well as the timing jitter of transit time from plume to plume. It is expected, however, that smaller diameters (e.g., below the 0.5 mm range) may run into limits imposed by the transition of the flow from laminar to transitional flow, which is expected to prohibit good transient formation, but it is possible for smaller diameters to be tested and they are considered within the scope of this disclosure.

The ID of the coupling tube is an important variable that may need to be determined case by case for a given system dimensions. Ablation chamber gas flow is set by the geometry of the sampling cone, its nearby region, and the total injector flow. The optimal total injector flow is determined by the properties of the ionization source torch. Changes to either one can necessitate changes to the optimal ID of the tubing.

### Taper

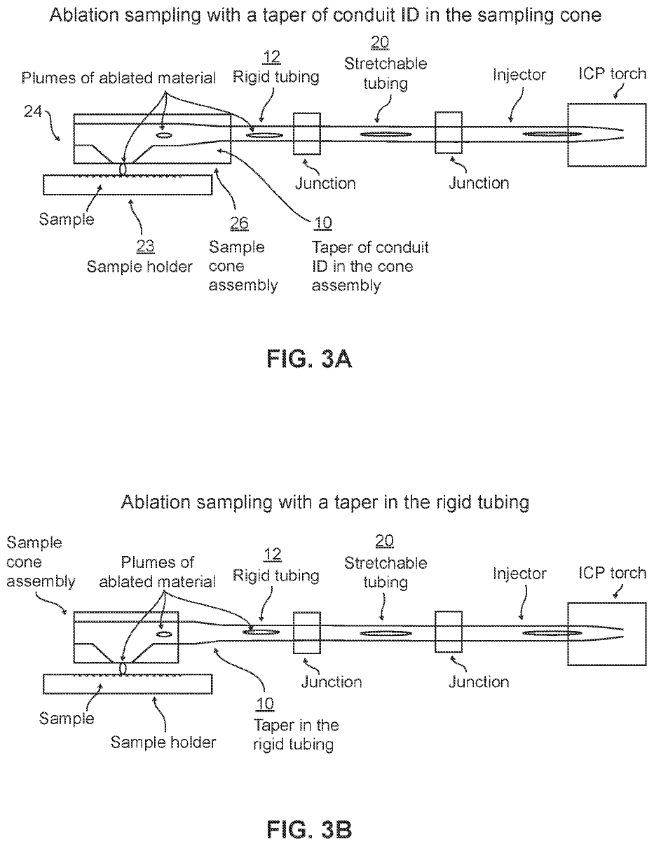

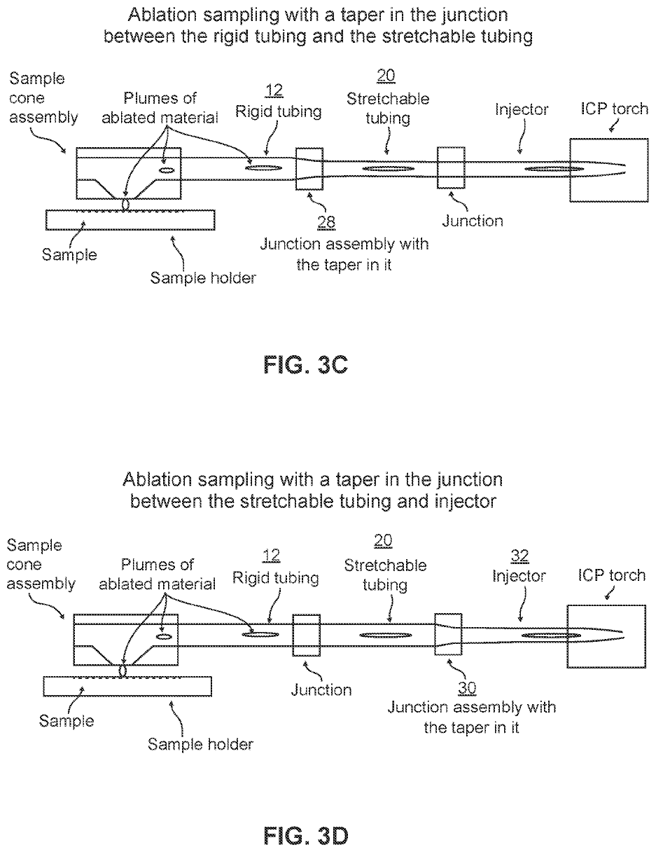

There may also be provided a taper at various portions in the system with respect to the coupling tube and its related components. In one example, there may be a taper 10 provided in the sampling cone 26 at the ablation chamber output of a laser ablation source 14. This is illustrated by FIG. 3A. The sampling cone 26 is coupled to one end of a rigid tubing 12. Providing the taper 10 at or inside the ablation sampling cone tube (on the output side of the cone) allows the taper 10 to occur as soon as possible after the ablation event, without substantially altering the gas flows in the vicinity of the ablation site. This approach may have the downside of making the taper location difficult to inspect/clean.

Gas can be provided from a gas supply source coupled to the laser ablation source 14. The laser ablation source 14 can include a sample holder 23, a laser source, and optics that direct a laser from the laser source to the sample holder 23. The system may additionally include a mass spectrometer for analyzing plasma products in the inductively coupled plasma chamber.

In another example, there may be a taper 10 provided in inner diameter of the rigid tubing 12, before flow enters the coupling tube 20. This is illustrated by FIG. 3B.

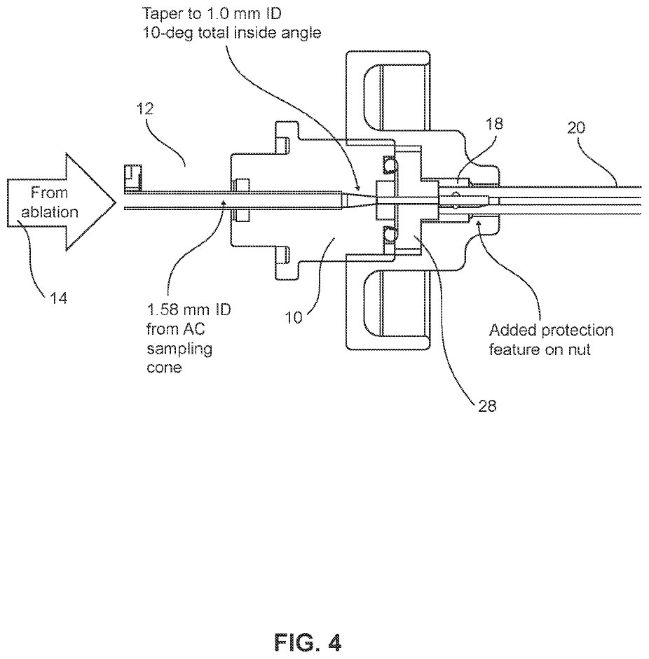

In a further example, there may be a taper 10 provided at the junction assembly 28 between the rigid tubing 12 and the coupling tube 20. This is illustrated by FIG. 3C and FIG. 4. As shown by FIG. 4, it is also possible to incorporates a barbed fitting 18 that is used to secure the coupling tube 20 into place. (Barbed fitting options are described more fully below.) In this option, it is possible for the taper 10 to be positioned within an element of a barbed fitting 18 (described in more detail below) on the coupling tube 20. Providing the taper 10 inside the junction assembly with the barbed fitting 18 can allow for easy inspection/cleaning of the taper. This approach may have the downside of making the two ends of the coupling tube assembly dissimilar (for example, if the output end of the coupling tube does not incorporate a similar taper).

In another example, there may be a taper 10 provided at the end of the coupling tube 20, at the junction assembly 30 where it connects to the injector 32. This is illustrated by FIG. 3D. The injector 32 can couple the laser ablation source to an inductively coupled plasma chamber.

These configurations can result in an increase of the transfer velocity and shorter transfer times, which are beneficial for reducing time broadening in plume transients. It is generally desirable to provide a low, gradual taper, which can help keep turbulence down. In one example, the taper may have about a 10° maximum angle taper. However, it should be understood that the taper angles may be anywhere between about 0.1 degree and about 180 degrees for the full angle. It is expected that 5-10 degrees may be a particularly useful taper angle range. The taper between the larger inner diameter region and the smaller inner diameter region can be made sufficiently slow to avoid the onset of the turbulence. In particular, the taper can be 10 degrees full angle or 5 degrees full angle. In some arrangements the taper can be 30 degrees or even 60 degrees. Transitions between the tapers and the entrance into each section of the system may be provided with smooth edges to suppress the onset of turbulence. Transitions can be piecewise linear and smoothed by curvatures or splines at the junctions on piecewise elements.

In one specific example, the taper may move from about a 1.6 mm inner diameter channel to about a 1.0 mm inner diameter coupling tube. The taper distance may be about 0 mm-50 mm. This distance is linked to the angle and the change in ID between the input and the output of the taper. As an example, 180-degree angle will result in 0 mm distance for the transition between larger ID that tapers to the smaller ID. Other ranges are of course possible and are considered within the scope of this disclosure. It is also possible to provide a stepped transition at various down-stepped angles, somewhat resembling the internal cross-section of an extended telescope or a smooth non-linear transition of a cone of a horn (e.g., a catenoidal horn, Bezier horn).

In the examples shown, the portion of the larger diameter section, before the taper, can stay relatively large (e.g., up to about ˜2 mm), which can simplify machining of the ablation sampling region and allows the main portion of the tubing to be made with a regular narrow bore tubing. The diameter of the narrowed bore section (the inner diameter of the tubing after the taper) is limited by the diameter corresponding to the onset of turbulence.

A Reynolds number can be calculated for a round tube and a known flow. In general, a Reynolds number above 4000 will indicate a turbulent flow in a round tube and thus should be avoided. For a given mass flow of gas, the Reynolds number is inversely proportional to the diameter of the conduit. Thus, the diameter of the conduit becomes limited on the small size by the Reynolds number and the onset of the turbulence in the flow. For a typical instrument setup, the ID of the narrowed portion of the conduit can be on the order of about 0.5 mm to about 1.0 mm.

Referring now to FIG. 4, there is shown a taper 10 that reduces to 1.0 mm from the 1.58 mm ID of the rigid tubing 12 from the ablation source 14. The taper 10 is shown positioned inside the ablation chamber output plug 16. However, it should be understood that it is also possible for the taper 10 to be positioned inside the 1.58 mm ID tubing itself (the current dimensions of the injector tubing from the sampling cone).

The location of the taper within the system can be changed to any appropriate location. The general goal is provide a taper somewhere in the ablation plume conduit located between the area where ablation happens and the tip of the injector into the plasma.

Additionally, the taper dimensions (angles, IDs and lengths) may vary and may be applied to any location of the taper. It is also possible to arrange more than one taper along the length of the flow path. For example, there may be two tapers or three tapers provided along the length of the conduit. This may incorporate any of the taper locations described herein. For instance, a first taper can be from 1.6 mm to 1.0 mm ID and it could be located in the rigid tubing 12. A second taper could be from 1.0 mm to 0.6 mm ID and it could be located at the junction assembly 30 between the coupling tube 20 and the injector 32.

### Barbed Ends for Coupling

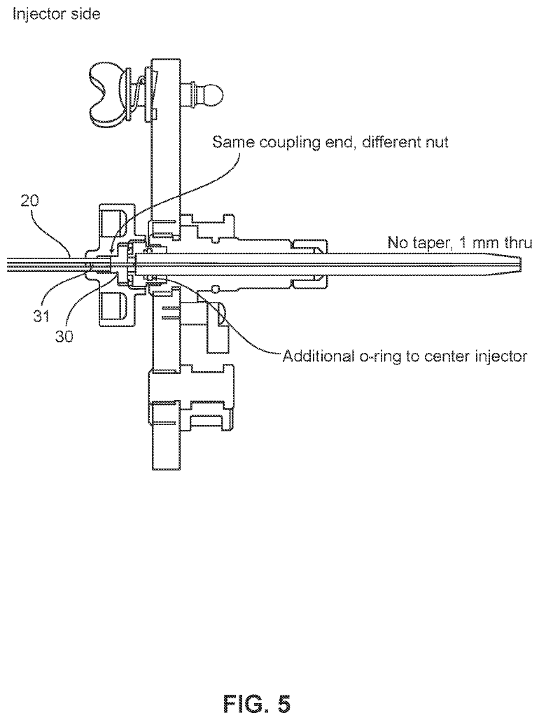

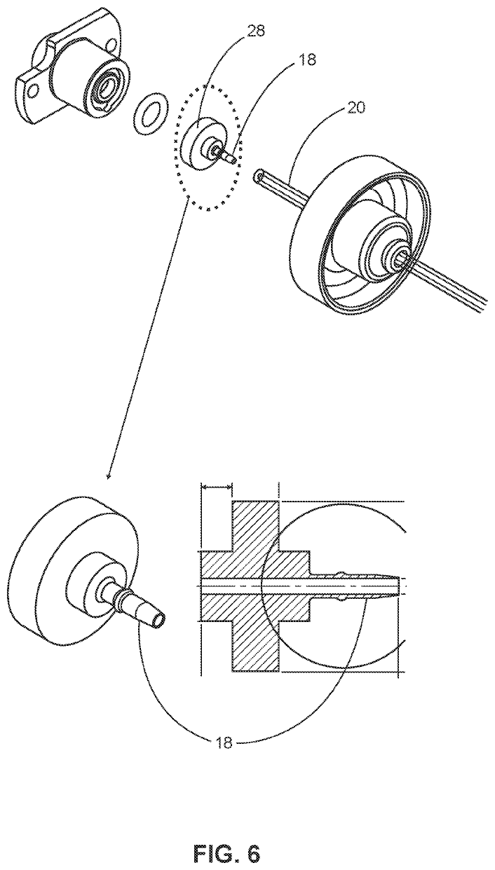

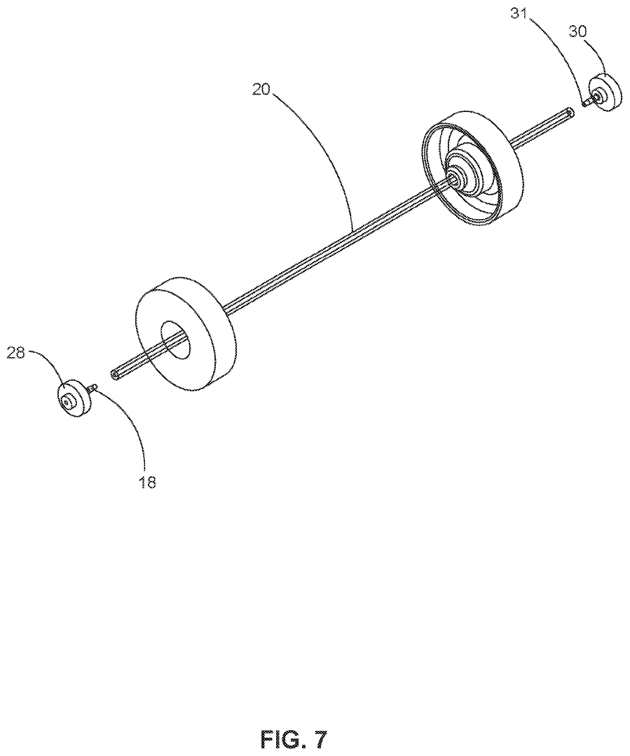

In a further aspect, there may be provided one or more machined barbed fittings 18, 31 on a junction assembly 28 and/or a junction assembly 30. For instance, barbed fitting 18 may be provided on junction assembly 28 and barbed fitting 31 may be provided on junction assembly 30. It is also possible for multiple barbed fittings to be coupled to junction assembly 28 or multiple barbed fittings to be coupled to junction assembly 30. The one or more machined barbed fittings 18, 31 may be configured to mate to coupling tube 20, examples of which are shown by FIGS. 4-7. The junction assembly 28, 30 with a barbed fitting 18, 31 can help ensure a secure attachment of the coupling tube 20 to the junction assembly (28, 30) at its end. The machined barbed fitting 18 on the junction assembly 28 and/or the machined barbed fitting 31 on the junction assembly 30 provide notable improvements over the previous coupling design. First, they may be made from stainless steel or other metal materials, rather than Delrin plastic. This means that the tolerances on the dimensions of the finished part can be higher, resulting in better centration matching at the junction between the end of the rigid tubing 12 and the beginning of the coupling tube 20. The ID of the machined end of the barbed fitting 18 that is received by the coupling tube 20 can be close to perfectly round, since it can be machined into metal (e.g., stainless steel). Next, the use of a barbed fitting 18 does away with the need to use glue in the assembly, which removes another potential source of assembly variability. The performance of the system is not strongly affected by the circular discontinuity in the ID surface caused by the end of the barb. Because the barb is a relatively small and can be a perfectly circular perturbation along the inner surface of the coupling tube 20, it does not create a significant source of transient broadening. Using barbs makes the assembly of the system more straightforward, eliminating the need for gluing as done in the old design, which presented a significant manufacturing challenge. The material of the stretchable tubing is also well-suited for making a sealed barbed connection that withstands many connection/disconnection cycles (unlike the hard bendable plastic material used in the original coupling tube). The original coupling tube uses FEP material, which is bendable but not stretchable. If it is inserted over a barb, it will not clamp to the barb with sufficient strength, leading to potential air and argon leaks in the conduit. Therefore, bendable tubing material is glued into the junction assembly. Stretchable tubing material can be used with the barb connection which provides the benefits described above.

### Installation

The coupling tube 20 is cut to length, strung through coupling nuts, and pushed onto the barb fittings 18 at either end. A coupling alignment jig is designed to ensure that the coupling tube can be made taut by adjusting separation between instruments, for expected range of tolerance stack-up (e.g., +/−5 mm RMS). A coupling tube pull test may be conducted, to ensure that the coupling tube ends do not easily pull out upon movement between the instruments. In one exemplary pull test for a 1.0 mm PVC coupling pull test, the coupling end did not pull out until after ˜2 kg of pull force was applied. The coupling tube exhibited about 46 mm (˜20%) of stretch before failure. Based on these results, it may be possible to rely entirely on the stretch of the coupling tube to take-up the variation in the axial distance machine-to-machine.

### EXAMPLES

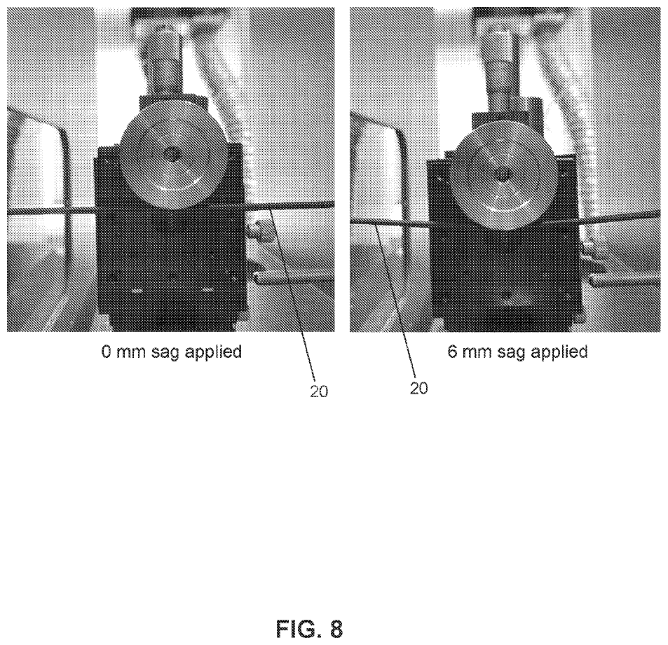

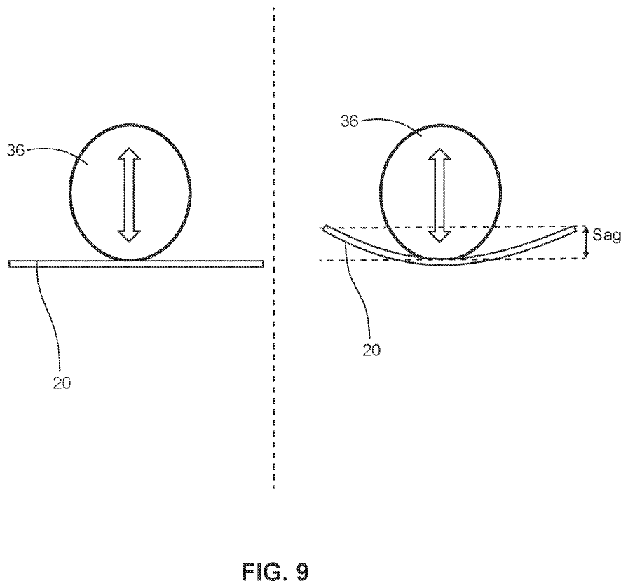

Tests were conducted to determine how much a coupling tube can be sagged during a life test experiment before the coupling tube begins to affect transients. FIG. 8 illustrates a test setup using a 2 inch optical post on a linear stage, driven downwards into a fixed coupling tube 20. The imaging instrument was set up using a coupling alignment jig to ensure a straight coupling tube 20. An apparatus was added to the system, which pushes downwards on the top of the coupling tube 20 to simulate the effect of a sagging coupling tube. A schematic of the apparatus is shown in FIG. 9. The apparatus includes a vertical positioning stage with a 2-inch diameter cylindrical pushing element 36 which contacted the coupling tube 20. The pushing element 36 was advanced into the coupling tube 20 in 0.5 mm steps, and the transient quality was recorded for each position. The starting position had the pushing element 36 just touching the coupling tube 20. The testing terminated once the system no longer passed CT40<12%. For all gas flows, 6.5 mm of total sag (illustrated by the double arrow in FIG. 9) was required to result in the coupling tube 20 failing CT400. It was determined that a deflection of the center of the coupling tube 20 by as little as 1 mm produced a measurable difference in transient quality.

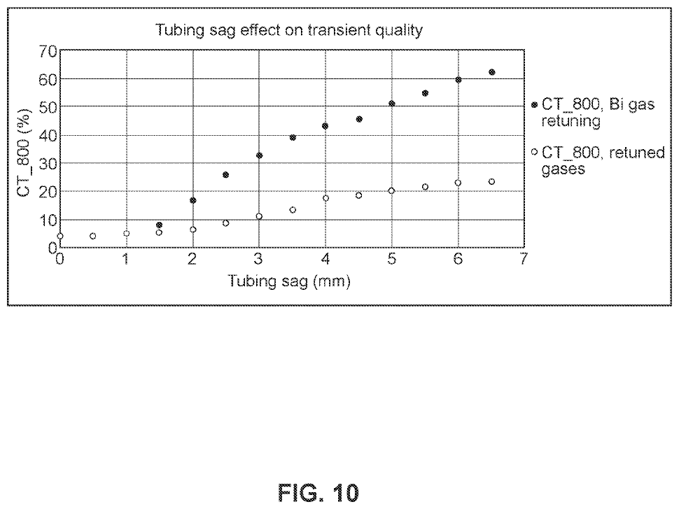

FIG. 10 shows a graph plotting 800 Hz plume crosstalk against the applied sag that was added to the coupling tube. Applying a sag to the coupling tube without retuning gas flows is shown to reduce the quality of the transients quickly (blue/top data points). Improvement can be achieved by retuning the gas flows after the coupling tube becomes bent (orange/bottom data points), but the coupling tube never returns to the low crosstalk values that were obtained with a straight coupling tube. These results demonstrate the benefit of a stretchable coupling tube that stays substantially straight in normal use due to elasticity of the material.

### Example Methods

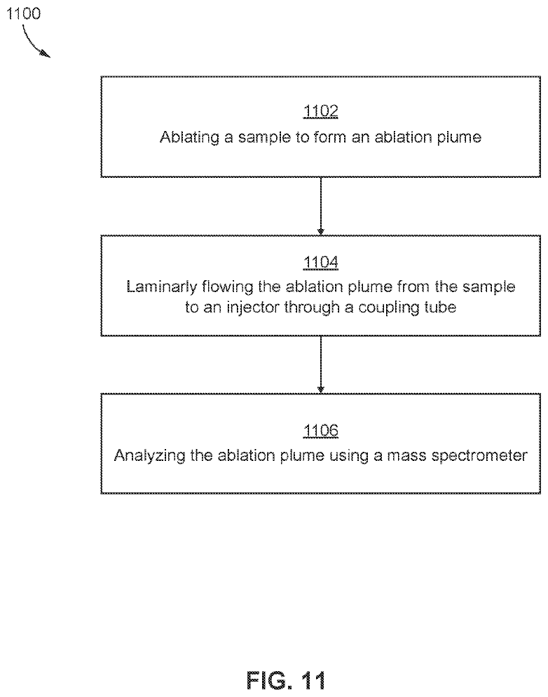

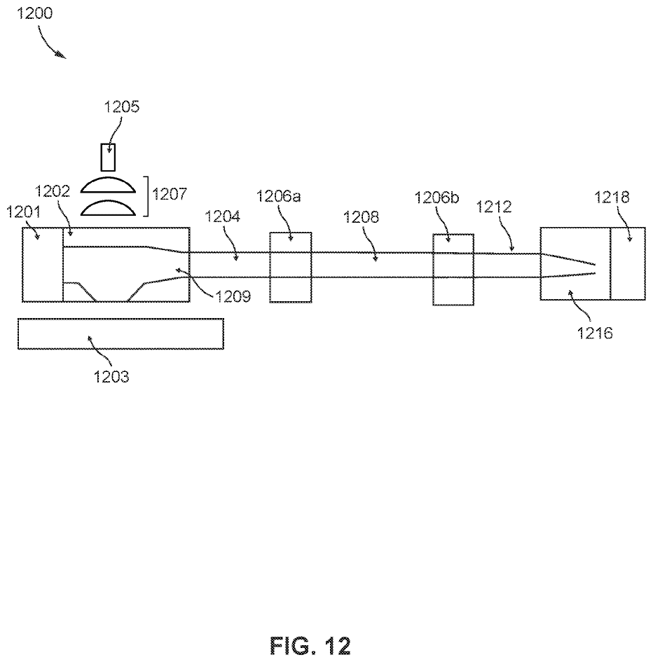

FIG. 11 illustrates a flowchart of an example of a process for using a coupling tube for ablation sampling. In some implementations, one or more process blocks of FIG. 11 may be performed by one or more components of a system 1200 in FIG. 12.

At block 1102, a sample is ablated to form an ablation plume. A configuration of optics of a laser ablation source 1202 can direct a laser from a laser source to a sample holder that holds the sample. The sample may be a biological sample, such as cells, tissues, etc. labeled with elemental tags. The laser pulse generates the ablation plume that can be transferred to be ionized for further analysis by a mass analyzer.

At block 1104, the ablation plume is laminarly flowed from the sample to an injector 1212 through a coupling tube 1208. The coupling tube 1208 can be made of a stretchable elastomeric material, such as fluoroelastomers. In addition, the coupling tube 1208 can have an inner diameter in a range from 0.3 mm to 6.0 mm. Before flowing through the coupling tube 1208, the ablation plume can flow through a rigid tubing 1204 that is coupled to the laser ablation source 1202 and then through a barbed fitting of a junction assembly 1206a that couples the rigid tubing 1204 to the coupling tube 1208. The ablation plume can flow from the coupling tube 1208 through another barbed fitting of another junction assembly 1206b that couples the coupling tube 1208 to the injector 1212.

In some examples, one or more components may include a taper to increase the transfer velocity and reduce transfer times for the ablation plume. The increased transfer velocity and reduced transfer times are beneficial for reducing time broadening in plume transients. The taper may be in the laser ablation source 1202, the rigid tubing 1204, one or more of the junction assemblies 1206a-b, the coupling tube 1208, or a combination thereof.

At block 1106, the ablation plume is analyzed using an inductively coupled plasma mass spectrometer any other ionization source and any mass analyzer described herein. The inductively coupled plasma mass spectrometer can include an inductively coupled plasma chamber 1216 and a mass spectrometer 1218. The injector 1212 can couple the coupling tube 1208 to the inductively coupled plasma mass spectrometer and the mass spectrometer 1218 can analyze plasma products in the inductively coupled plasma chamber 1216. The information acquired from the laser pulse on the sample may be used for imaging the sample based on its analyzed content.

Process 1100 may include additional implementations, such as any single implementation or any combination of implementations described below and/or in connection with one or more other processes described elsewhere herein.

Although FIG. 11 shows example blocks of process 1100, in some implementations, process 1100 may include additional blocks, fewer blocks, different blocks, or differently arranged blocks than those depicted in FIG. 11. Additionally, or alternatively, two or more of the blocks of process 1100 may be performed in parallel.

### Example Systems

FIG. 12 illustrates a schematic of an example of a system 1200 for using a coupling tube for ablation sampling. The system 1200 includes a laser ablation source 1202, a rigid tubing 1204, a coupling tube 1208, an injector 1212, and an inductively coupled plasma chamber 1216, and a mass spectrometer 1218. The injector 1212 can operably couple the laser ablation source 1202 to the inductively coupled plasma chamber 1216, and the coupling tube 1208 can operably couple the laser ablation source 1202 to the injector 1212 for transferring ablation plumes from the laser ablation source 1202 to the injector 1212. Operably coupled may mean that components are directly coupled to each other (e.g., in direct contact) or indirectly coupled with each other (e.g., with one or more intermediate components between the coupled components).

The laser ablation source 1202 can include a sample holder 1203, a laser source 1205, and a configuration of optics 1207 to direct a laser from the laser source 1205 to the sample holder 1203. The laser ablation source 1202 can receive gas flow from a gas supply source 1201 that is coupled to the laser ablation source 1202. The laser ablation source 1202 can also include a sampling cone 1209 that is operably coupled to the rigid tubing 1204. The sampling cone 1209 can be tapered to have a smaller diameter proximate to the rigid tubing 1204 compared to distal to the rigid tubing 1204 (e.g., sample cone assembly 26 in FIG. 3A).

The coupling tube 1208 can include a stretchable elastomeric material, such as fluoroelastomers, and may be characterized by a first inner diameter in a range from 0.3 mm to 6.0 mm, including 0.3 mm to 0.5 mm, 0.5 mm to 1.0 mm, 1.0 mm to 2.0 mm, 2.0 mm to 3.0 mm, 3.0 mm to 4.0 mm, 4.0 mm to 5.0 mm, or 5.0 mm to 6.0 mm. The coupling tube 1208 may be the coupling tube 20 or any stretchable tubing described herein, the laser ablation source 1202 may be the laser ablation source 24 or any laser ablation source described herein, the rigid tubing 1204 may be the rigid tubing 12 or any rigid tubing described herein, and the injector 1212 may be the injector 32 or any injector described herein.

The rigid tubing 1204 can be operably coupled to the coupling tube 1208. A first end of the rigid tubing 1204 can be operably coupled to the laser ablation source 1202, and a second end of the rigid tubing can be operably coupled to the coupling tube 1208. The rigid tubing 1204 can be characterized by a second inner diameter at the first end that is larger than the first inner diameter of the coupling tube 1208. The second diameter may be up to 2.0 mm (e.g., 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, or a diameter between and including any two of these numbers).

Additionally, the rigid tubing 1208 can be characterized by a third inner diameter at the second end, and the second inner diameter can be larger than the third inner diameter. The rigid tubing 1204 can include a taper (e.g., up to a 10-degree taper) that narrows the third inner diameter at the second end leading to the coupling tube 1208 in a range from 0.5 mm to 1.0 mm, in a range from 0.5 mm to 0.6 mm, in a range from 0.6 mm to 0.7 mm, in a range from 0.7 mm to 0.8 mm, in a range from 0.8 mm to 0.9 mm, or in a range from 0.9 mm to 1.0 mm. In one specific example, the taper may move from about a 1.6 mm inner diameter to about a 1.0 mm inner diameter, with a taper distance of between 0 mm to 50 mm.

The system 1200 can also include one or more junction assemblies (e.g., junction assembly 1206a and junction assembly 1206b) that can cooperate with at least one end of the coupling tube 1208. For instance, junction assembly 1206a can couple the rigid tubing 1204 to the coupling tube 1208, and junction assembly 1206b can couple the coupling tube 1208 to the injector 1212. The junction assemblies 1206a-b can each include a barbed fitting (e.g., barbed fitting 18) that cooperates with the coupling tube 1208. The barbed fitting can include a taper that reduces diameter leading to the coupling tube 1208 or to the injector 1212. The junction assemblies 1206a-b may be the junction assembly 28 or any junction assembly described herein.

The mass spectrometer 1218 can analyze plasma products in the inductively coupled plasma chamber 1216. System 1200 may include electrical circuitry and other components to strike a plasma within the inductively coupled plasma chamber 1216. In some embodiments, an ionization chamber may be used in place of the inductively coupled plasma chamber 1216. In embodiments, system 1200 may also include electrical circuitry and other components to ionize material in the ionization chamber.

The subject matter of certain embodiments of this disclosure is described with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

It should be understood that different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

Any of the methods described herein may be totally or partially performed with a computer system including one or more processors, which can be configured to perform the steps. For instance, the computer system may communicate with mass flow controllers, power supplies, and other control systems. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order that is logically possible. Additionally, portions of these steps may be used with portions of other steps from other methods. Also, all or portions of a step may be optional. Additionally, any of the steps of any of the methods can be performed with modules, units, circuits, or other means of a system for performing these steps.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

The above description of example embodiments of the present disclosure has been presented for the purposes of illustration and description and are set forth so as to provide those of ordinary skill in the art with a complete disclosure and description of how to make and use embodiments of the present disclosure. It is not intended to be exhaustive or to limit the disclosure to the precise form described nor are they intended to represent that the experiments are all or the only experiments performed. Although the disclosure has been described in some detail by way of illustration and example for purposes of clarity of understanding, it is readily apparent to those of ordinary skill in the art in light of the teachings of this disclosure that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the disclosure being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

The claims may be drafted to exclude any element which may be optional As such, this statement is intended to serve as antecedent basis for use of such exclusive terminology as “solely”, “only”, and the like in connection with the recitation of claim elements, or the use of a “negative” limitation.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within embodiments of the present disclosure. The upper and lower limits of these smaller ranges may independently be included or excluded in the range, and each range where either, neither, or both limits are included in the smaller ranges is also encompassed within the present disclosure, subject to any specifically excluded limit in the stated range. Where the stated range includes one or both of the limits, ranges excluding either or both of those included limits are also included in the present disclosure.

All patents, patent applications, publications, and descriptions mentioned herein are hereby incorporated by reference in their entirety for all purposes as if each individual publication or patent were specifically and individually indicated to be incorporated by reference and are incorporated herein by reference to disclose and describe the methods and/or materials in connection with which the publications are cited. None is admitted to be prior art.

What is claimed is:

1. A system comprising:
a laser ablation source;
an injector configured to operably couple the laser ablation source to an inductively coupled plasma chamber; and
a coupling tube configured to operably couple the laser ablation source to the injector for transferring a plurality of ablation plumes from the laser ablation source to the injector, wherein:
the coupling tube comprises a stretchable elastomeric material, and
the coupling tube is characterized by a first inner diameter in a range from 0.3 mm to 6.0 mm.

2. The system of claim 1, wherein the stretchable elastomeric material comprises fluoroelastomers.

3. The system of claim 1, further comprising a junction assembly comprising a barbed fitting configured to cooperate with at least one end of the coupling tube.

4. The system of claim 3, wherein the barbed fitting comprises a taper that reduces diameter leading to the coupling tube.

5. The system of claim 1, further comprising a rigid tubing configured to operably couple to the coupling tube, wherein:
the rigid tubing comprises a first end operably coupled to the laser ablation source; and
the rigid tubing comprises a second end operably coupled to the coupling tube;
the rigid tubing is characterized by a second inner diameter at the first end that is larger than the first inner diameter of the coupling tube;
the rigid tubing is characterized by a third inner diameter at the second end; and
the second inner diameter is larger than the third inner diameter.

6. The system of claim 5, wherein the second inner diameter is in a range from 1.5 mm to 2.0 mm.

7. The system of claim 5, wherein the rigid tubing comprises a 10-degree taper configured to narrow the third inner diameter at the second end leading to the coupling tube in a range from 0.5 mm to 1.0 mm.

8. The system of claim 1, further comprising a junction assembly between the coupling tube and the injector, wherein a taper occurs at the junction assembly that reduces diameter leading to the injector.

9. The system of claim 1, further comprising the inductively coupled plasma chamber.

10. The system of claim 1, further comprising a mass spectrometer configured to analyze plasma products in the inductively coupled plasma chamber.

11. The system of claim 1, wherein the laser ablation source comprises:
a sample holder,
a laser source, and
a configuration of optics to direct a laser from the laser source to the sample holder.

12. The system of claim 1, further comprising a gas supply source operably coupled to the laser ablation source.

13. An apparatus comprising:
an inductively coupled plasma chamber;
an injector configured to operably couple the inductively coupled plasma chamber to a laser ablation source; and
a coupling tube configured to operably couple the laser ablation source to the injector for transferring a plurality of ablation plumes from the laser ablation source to the injector, wherein:
the coupling tube comprises a stretchable elastomeric material, and
the coupling tube is characterized by a first inner diameter in a range from 0.3 mm to 6.0 mm.

14. The apparatus of claim 13, further comprising a rigid tubing operably coupled to the coupling tube, wherein:
the rigid tubing comprises a first end operably coupled to the laser ablation source; and
the rigid tubing comprises a second end operably coupled to the coupling tube;
the rigid tubing is characterized by a second inner diameter at the first end that is larger than the first inner diameter of the coupling tube;
the rigid tubing is characterized by a third inner diameter at the second end; and
the second inner diameter is larger than the third inner diameter.

15. The apparatus of claim 14, wherein the laser ablation source comprises a sampling cone,
the sampling cone is operably coupled to the first end of the rigid tubing, and
the sampling cone is tapered to have a smaller diameter proximate to the first end of the rigid tubing compared to distal to the first end of the rigid tubing.

16. The apparatus of claim 14, wherein the second inner diameter is in a range from 1.5 mm to 2.0 mm. 17 The apparatus of claim 14, wherein the rigid tubing comprises a 10-degree taper configured to narrow the third inner diameter at the second end leading to the coupling tube in a range from 0.5 mm to 1.0 mm.

18. The apparatus of claim 14, further comprising a junction assembly between the rigid tubing and the coupling tube, wherein a taper occurs at the junction assembly that reduces diameter leading to the coupling tube.

19. The apparatus of claim 18, wherein the junction assembly comprises a barbed fitting configured to cooperate with a third end of the coupling tube, and wherein the barbed fitting comprises the taper that reduces the diameter leading to the coupling tube.

20. The apparatus of claim 13, further comprising a junction assembly between the coupling tube and the injector, wherein a taper occurs at the junction assembly that reduces diameter leading to the injector.

21. The apparatus of claim 13, further comprising the laser ablation source.

22. The apparatus of claim 13, further comprising a mass spectrometer configured to analyze plasma products in the inductively coupled plasma chamber.

23. The apparatus of claim 13, wherein the laser ablation source comprises:
a sample holder,
a laser source, and
a configuration of optics to direct a laser from the laser source to the sample holder.

24. The apparatus of claim 13, further comprising a gas supply source operably coupled to the laser ablation source.

25. A method comprising:
ablating, by a laser, a sample to form an ablation plume;
laminarly flowing the ablation plume from the sample to an injector through a coupling tube, wherein:
the coupling tube comprises a stretchable elastomeric material, and
the coupling tube is characterized by a first inner diameter in a range from 0.3 mm to 6.0 mm; and
analyzing the ablation plume using an inductively coupled plasma mass spectrometer coupled to the injector.

26. The method of claim 25, wherein the stretchable elastomeric material comprises fluoroelastomers.

27. The method of claim 25, further comprising flowing the ablation plume through a barbed fitting of a junction assembly before or after flowing the ablation plume through the coupling tube.

28. The method of claim 25, further comprising flowing the ablation plume through a rigid tubing before flowing the ablation plume through the coupling tube, wherein:
the rigid tubing comprises a first end operably coupled to a laser ablation source comprising the laser; and
the rigid tubing comprises a second end operably coupled to the coupling tube;
the rigid tubing is characterized by a second inner diameter at the first end that is larger than the first inner diameter of the coupling tube;
the rigid tubing is characterized by a third inner diameter at the second end; and
the second inner diameter is larger than the third inner diameter.

29. The method of claim 28, wherein the second inner diameter is in a range from 1.5 mm to 2.0 mm.

30. The method of claim 28, wherein the rigid tubing comprises a 10-degree taper configured to narrow the third inner diameter at the second end leading to the coupling tube in a range from 0.5 mm to 1.0 mm.
